(19) United States
(12) Patent Application Publication
(10) Pub. No.: US 2018/0320657 A1
(43) Pub. Date: Nov. 8, 2018

(54) FLUID-DRIVEN POWER DEVICE

(71) Applicant: GRAND MATE CO., LTD., TAICHUNG CITY (TW)

(72) Inventors: CHUNG-CHIN HUANG, TAICHUNG CITY (TW); CHIN-YING HUANG, TAICHUNG CITY (TW); HSIN-MING HUANG, TAICHUNG CITY (TW); HSING-HSIUNG HUANG, TAICHUNG CITY (TW); YEN-JEN YEH, TAICHUNG CITY (TW); WEI-LONG CHEN, TAICHUNG CITY (TW); KUAN-CHOU LIN, TAICHUNG CITY (TW); TANG-YUAN LUO, TAICHUNG CITY (TW)

(21) Appl. No.: 15/586,795

(22) Filed: May 4, 2017

(51) Int. Cl. F03D 3/06; F03D 3/00

(52) U.S. Cl. CPC F03D 3/064; F03D 3/065; F03D 3/005

(57) ABSTRACT

A fluid-driven power device is provided, including two fixed plates and a plurality of vanes. The two fixed plates are spaced out a distance, and respectively have two inner surfaces face each other, wherein a central axis passes through centers of the two inner surfaces. The vanes are provided between the two fixed plates and around the central axis. Two connected ends of each vane are respectively connected to the inner surface of the two fixed plates. Each vane forms a spiral twist, and the torsion angle of each of the vanes is changed from a central portion between the two connected ends toward the two connected ends in a symmetrical manner. Whereby the vanes can rectify the fluid, and prevents the output fluid from forming turbulence which interferes with rotation of the power device. Therefore, the rotation speed and efficiency of the power device will be further improved.

### BACKGROUND OF THE INVENTION

### 1. Technical Field

The present invention relates generally to power generation, and more particularly to a fluid-driven power device.

### 2. Description of Related Art

Fluid-driven power devices are driven by air or liquid flow, and commonly used for wind power generation or hydropower generation. Currently used power devices for wind power generation are divided into two types, which are horizontal-axis type and vertical-axis type. A shaft of a horizontal-axis type power device is parallel to wind direction. The advantage of such design is that the power generation efficiency of the relevant power generation apparatus is high because the shaft rotates fast when wind speed is high. On the other hand, the drawback of a horizontal-axis type power device is that it makes a loud noise, needs a high cut-in wind velocity, and has to be set in an open space without shelter such as the seaside. Moreover, vanes of a horizontal-axis type power device have to be adjusted according to wind direction, so a tail vane and a steering mechanism have to be installed on for operation. As for a vertical-axis type power device, a shaft thereof is vertical to wind direction. The advantage of such design is that the occupied space is small, and the cut-in wind velocity is relatively low. Furthermore, a vertical-axis type power device is adapted to any places such as metropolitan areas and suburbs, and it's safer during construction or operation. However, the rotation speed of the shaft and the vanes are slower (tip speed ratio≤1), which is unconducive to power generation.

Nevertheless, no matter what the type is, a conventional power device creates turbulence when vanes are rotating, which interferes with vane rotation, and thus the rotation speed of the power device can not be effectively increased. Additionally, turbulence causes vibration and noise of a power device.

### BRIEF SUMMARY OF THE INVENTION

In view of the above, the primary objective of the present invention is to provide a fluid-driven power device which suppresses turbulence and effectively increases the efficiency of utilization of fluid.

The present invention provides a fluid-driven power device, including two fixed plates and a plurality of vanes. Each of the two fixed plates has an inner surface. The two fixed plates are spaced out a distance, and the two inner surfaces face each other. A central axis passes through centers of the two inner surfaces. The plurality of vanes are provided between the two fixed plates and around the central axis, wherein each of the vanes has two connected ends opposite to each other. The two connected ends are connected to the inner surfaces of the two fixed plates respectively. Each of vanes forms a spiral twist, and the torsion angle of each of the vanes is changed from a central portion between the two connected ends toward the two connected ends in a symmetrical manner.

Whereby, the spirally twisted vanes each with symmetrical torsion angles can rectify the fluid, and prevents the output fluid from forming turbulence which interferes with rotation of the power device. Therefore, the rotation speed and efficiency of the power device will be further improved whereby the efficiency of utilization of fluid will be effectively increased.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a perspective view of a first embodiment of the present invention;

FIG. 2 is an exploded view of the first embodiment;

FIG. 3 is a lateral view of the first embodiment;

FIG. 4 is sectional views (a)-(e) taken along the A-A′ to E-E′ lines in FIG. 3 respectively;

FIG. 5 is a curve chart of the first embodiment, showing the relation of positions on each vane between the two connected ends and the corresponding torsion angles;

FIG. 6 is a schematic diagram of the first embodiment, showing the flow direction of the fluid during the fluid drives the power device; and

FIG. 7 is a mimic diagram of the first embodiment, simulating the flow field during the fluid drives the power device.

### DETAILED DESCRIPTION OF THE INVENTION

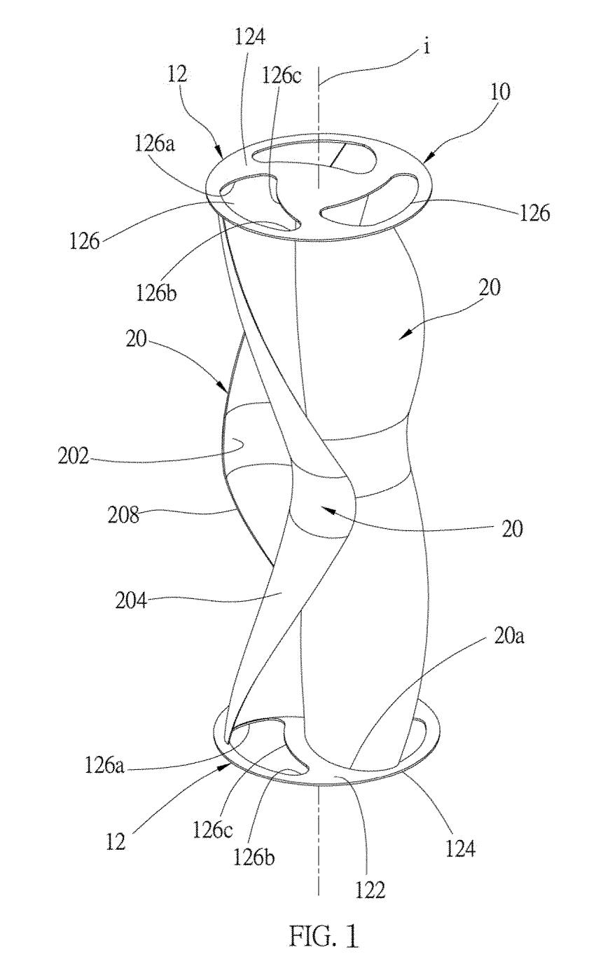

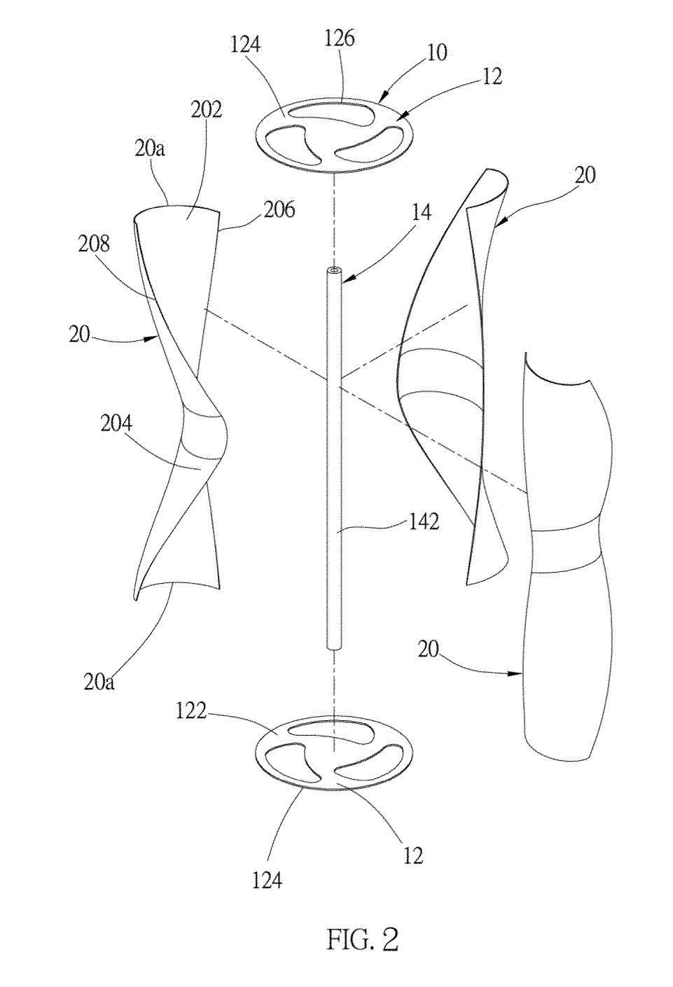

As shown in FIG. 1 to FIG. 4, a fluid-driven power device, the first embodiment of the present invention, is adapted to be connected to a transmission (not shown) such as a dynamo. The power device includes a support member 10 and a plurality of vanes 20.

The support member 10 is adapted to be connected to the transmission, and includes two fixed plates 12 and a pillar 14. Each of the fixed plates 12 is a circular plate, and has an inner surface 122 and an outer surface 124 which is opposite to the inner surface 122. The two fixed plates 12 are spaced out a distance, and the two inner surfaces 122 face each other. A central axis i passes through centers of the two inner surfaces 122 and the two outer surfaces 124 of the two fixed plates 12. Each of the fixed plates 12 has a plurality of openings 126 therein formed from the inner surface 122 to the outer surface 124, wherein the openings 126 of each of the fixed plates 12 surround the central axis i. Each of the openings 126 has a first end 126a and a second end 126b, wherein the width of each of the openings 126 tapers off from the first end 126a to the second end 126b. Rims of the first end 126a and the second end 126b are arc-shaped. Each of the openings 126 has an inner rim 126c between the first end 126a and the second end 126b, the distance between the inner rim 126c and the central axis i is increased from the first end 126a to the second end 126b. Each of the openings 126 of one of the two fixed plates 12 corresponds to one of the openings 126 of another of the two fixed plates 12. However, in another embodiment, the openings 126 of the fixed plates 12 can be omitted.

The pillar 14 is a cylinder connecting the two fixed plates 12, and is aligned to the central axis i. In the first embodiment, two ends of the pillar 14 are respectively connected to the centers of the inner surfaces 122 of the two fixed plates 12. The outer surface 124 of the at least one of the fixed plates 12 is connected to a transmission. Practically, in another embodiment, the pillar 14 protrudes from the outer surface 124 of the fixed plate 12 to be connected to a transmission. However, in another embodiment, the pillar 14 can also be omitted.

The vanes 20 are long and provided between the two fixed plates 12, and are evenly distributed and center around the central axis i. The vanes 20 have the same structure which has two connected ends 20a opposite to each other, wherein each of the vanes 20 has an inner surface 202, an outer surface 204, an inner edge 206, and an outer edge 208 between the two connected ends 20a. The inner edge 206 and the outer edge 208 connect the inner surface 202 and the outer surface 204, and are opposite to each other. The two connected ends 20a are connected to the inner surfaces 122 of the two fixed plates 12 respectively. In the first embodiment, each of the openings 126 of each of the fixed plates 12 is located between two connected ends 20a of adjacent two of the vanes 20. Furthermore, a part of the connected end 20a of each of the vanes 20 is situated along the first end 126a of one of the openings 126, and the part of the connected end 20a has a shape matching with the first end 126a. Each of the inner surfaces 202 of the vanes 20 faces the outer surface 204 of another vane 20; the inner edge 206 of each vane 20 is closer to the central axis i than the outer edge 208. The vanes 20 are located within the projection range of the inner surfaces 122 of the two fixed plates 12.

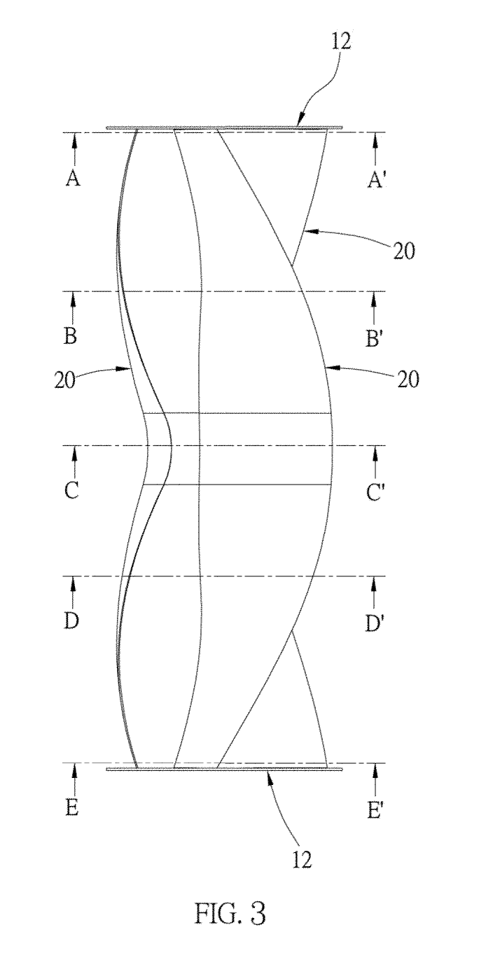

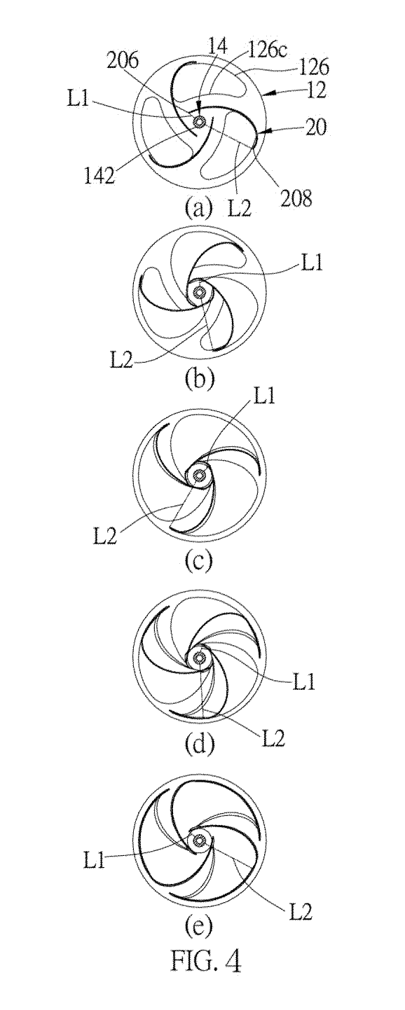

As shown in FIG. 3 and FIG. 4, the vanes 20 in each cross sections are airfoil-shaped, and form a spiral twist along with the change of a pitch along an axial direction. It is illustrated in FIG. 4 that the sectional views are vertical to the central axis i, and the outer surface 204 of each vane 20 bends toward the inner surface 202, wherein the bending shape is shown as involute; the bending shapes of the vanes 20 in each sectional view are the same. A minimum distance L1 between any position on the inner edge 206 between the two connected ends 20a of each vane 20 and the outer surface 142 of the pillar 14 is the same; a minimum distance L2 between any position on the outer edge 208 between the two connected ends 20a and the outer surface 142 of the pillar 14 is the same.

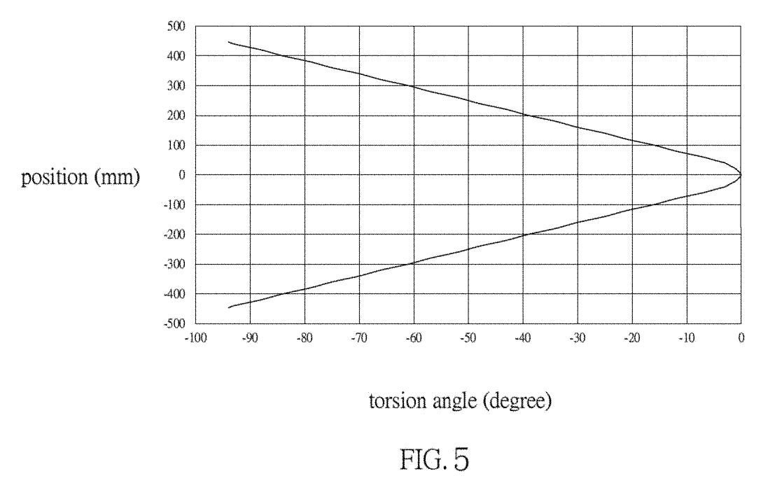

FIG. 5 depicts the relation of positions on each vane 20 between the two connected ends 20a and the corresponding torsion angles which change with different positions. The central portion between the two connected ends 20a is defined as the position 0 mm, and the positions of the two connected ends are 447 mm and −447 mm respectively. As obviously shown in FIG. 5, the torsion angle of each vane 20 is changed from the central portion between the two connected ends 20a toward the two connected ends 20a in a symmetrical manner. The difference of the torsion angles of the vane 20 between the central portion and each connected end 20a is 94 degrees, which can be 45 to 100 degrees practically.

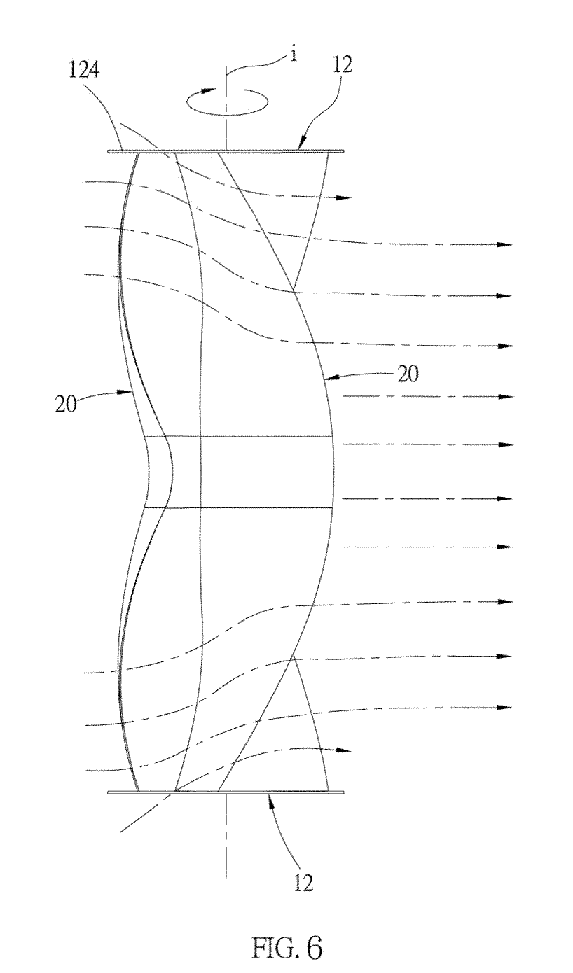

As shown in FIG. 6, with the aforementioned design, during fluid turbulence passes and turns the power device, the fluid flows between two adjacent vanes 20, and then is guided by the inner surface 202 of one of two adjacent vanes 20 and the outer surface 204 of another of the two adjacent vanes 20 to be led to the center of the two connected ends 20a of the each vane 20. Such guiding process rectifies fluid and compresses fluid toward the center of the vane 20. Accordingly, turbulence generated after a fluid passes through the power device is reduced, and thus the fluid can outflow from the power device steadily. During the guiding process, fluid near the outer surface 124 would also be guided to space between two adjacent vanes 20 and the center of each vane 20 through the openings 126 above the two fixed plates 12 for reducing the interference of the turbulence outside the fixed plates 12.

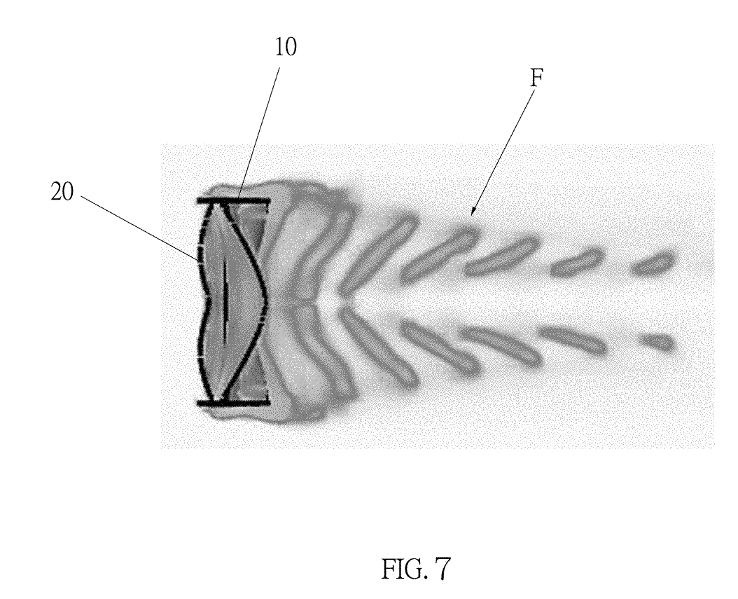

It is obviously shown in FIG. 7, the mimic diagram of the flow field, that the fluid F outflow from the power device steadily such that the fluid F will not develop turbulence which interferes with the rotation of the power device. Therefore, the rotation speed and efficiency of the power device will be further improved whereby the efficiency of utilization of fluid F will be effectively increased.

In conclusion, the abovementioned power device used to be driven by air flow includes vanes 20 which are airfoil-shaped in cross sections and form a spiral twist along an axial direction. With such design, the flow passing through the vanes 20 would be increased, and the tip speed ratio would also be increased to 1.4 which is greater than that of a conventional vertical-axis type power device (≤1). In addition, a cut-in wind velocity smaller than 4M/s can drive the power device to rotate, and the advantages of the power device are that the occupied space is small, and has a low noise.

However, in another embodiment, the fluid which drives the power device can be liquid flow. It must be pointed out that the embodiments described above are only some preferred embodiments of the present invention. All equivalent structures which employ the concepts disclosed in this specification and the appended claims should fall within the scope of the present invention.

What is claimed is:

1. A fluid-driven power device, comprising:
two fixed plates, wherein each of the two fixed plates has an inner surface; the two fixed plates are spaced out a distance, and the two inner surfaces face each other; a central axis passes through centers of the two inner surfaces; and
a plurality of vanes provided between the two fixed plates and around the central axis, wherein each of the vanes has two connected ends opposite to each other; the two connected ends are connected to the inner surfaces of the two fixed plates respectively;
wherein each of vanes forms a spiral twist, and the torsion angle of each of the vanes is changed from a central portion between the two connected ends toward the two connected ends in a symmetrical manner.

2. The fluid-driven power device of claim 1, wherein each of the vanes in any cross section perpendicular to the central axis is bending-draped.

3. The fluid-driven power device of claim 2, wherein the bending shape of each of the vanes in any cross section perpendicular to the central axis is shown as involute.

4. The fluid-driven power device of claim 2, wherein the bending shapes of each of the vanes in any cross sections perpendicular to the central axis are the same.

5. The fluid-driven power device of claim 1, wherein the difference of the torsion angles of each of the vanes between the central portion and each of the connected ends is between 45 degrees and 100 degrees.

6. The fluid-driven power device of claim 1, further comprising a pillar connecting the two fixed plates, wherein the pillar is aligned to the central axis.

7. The fluid-driven power device of claim 6, wherein each of the vanes has an inner edge and an outer edge which are opposite to each other between the two connected ends, and the inner edge is closer to the central axis than the outer edge; a minimum distance between any position on the inner edge between the two connected ends of each of the vanes and an outer surface of the pillar is the same; a minimum distance between any position on the outer edge between the two connected ends of each of the vanes and the outer surface of the pillar is the same.

8. The fluid-driven power device of claim 1, wherein each of the fixed plates has an outer surface opposite to the inner surface; each of the fixed plates has plurality of openings formed from the inner surface to the outer surface, wherein each of the openings is located between two connected ends of adjacent two of the vanes.

9. The fluid-driven power device of claim 8, wherein each of the openings has a first end and a second end; a width of each of the openings tapers off from the first end to the second end.

10. The fluid-driven power device of claim 8, wherein a part of each of the connected ends of each of the vanes is situated along the first end of one of the openings.

11. The fluid-driven power device of claim 1, wherein the vanes are located within a projection range of the inner surfaces of the two fixed plates.
